(19) United States
(12) Patent Application Publication
(10) Pub. No.: US 2014/0174593 A1
(43) Pub. Date: Jun. 26, 2014

(54) Method for Filling a Tank with Pressurized Gas

(71) Applicants: Fouad Ammouri, Massy (FR); Jonathan Macron, Paris (FR)

(72) Inventors: Fouad Ammouri, Massy (FR); Jonathan Macron, Paris (FR)

(73) Assignee: L'Air Liquide, Societe Anonyme pour I'Etude et I'Exploitation des Procedes Georges Claude, Paris (FR)

(21) Appl. No.: 14/234,330

(22) PCT Filed: Jun. 13, 2012
(86) PCT No.: PCT/FR2012/051319

§ 371 Date: Jan. 22, 2014

(30) Foreign Application Priority Data
Jul. 22, 2011 (FR) 1156653

(51) Int. Cl. F17C 5/06

(52) U.S. Cl. CPC F17C 5/06
USPC 141/4

(57) ABSTRACT

Method for filling a tank with pressurised gas, the method comprising:
a step of measuring the initial pressure (P(t0)) in the tank,
a step of determining the initial quantity (m(t0)) of gas in the tank,
a step of measuring the current pressure (P(ti)) in the tank,
a step of determining the current quantity (Q(ti)) of gas transferred into the tank,
a step of calculating the current quantity (m(ti)) of gas in the tank,
a step of determining the current temperature (T(ti)) of the gas in the tank,

the method being characterised in that, for the step of determining the current temperature (T(ti)) of the gas in the tank, said temperature (T(ti)) is expressed and calculated solely as a function of the variables consisting of the current pressure (P(ti)) in the tank and the current quantity (m(ti)) of gas in the tank; the expression of the current temperature (T(ti)) as a function of the current pressure (P(ti)) and the current quantity (m(ti)) of gas in the tank being obtained from the state equation for the real gases in the tank P(ti)·V·10⁵=Z·n·R·T(ti), the compressibility factor Z being expressed as a function of the temperature T(ti) and the pressure P(ti) of the gas in the tank according to a first-degree formula Z(ti)=(e·T(ti)+f)·P(ti)+g.

The present invention concerns a method for filling a tank with pressurised gas.

The invention concerns more particularly a method for filling a tank with pressurised gas, in particular gaseous hydrogen, to achieve a predetermined target filling level, the filling being interrupted when a measured or estimated physical quantity of the gas in the tank corresponds to the target filling level or when the temperature in the tank reaches a given maximum threshold, the method comprising:
a step of measuring the initial pressure (P(t0)) in the tank before filling,
a step of determining the initial quantity (m(t0)) of gas in the tank before filling,
a step of measuring the current pressure (P(ti)) in the tank during filling,
a step of determining the current quantity (Q(ti)) of gas transferred into the tank during filling,
a step of calculating the current quantity (m(ti)) of gas in the tank during filling,
a step of determining the current temperature (T(ti)) of the gas in the tank during filling.

The invention applies preferentially to rapid fillings (that is to say around three to fifteen minutes for example) of gas tanks containing hydrogen at high pressures (for example between 300 and 850 bars).

Filling high-pressure gaseous hydrogen tanks on motor vehicles is made difficult because of numerous technical constraints. This is because the filling must be optimised both from the point of view of the quantity transferred and the duration of filling, without causing heating of the tank incompatible with the structure thereof. In addition, to ensure optimum filling, it is preferable to know the geometric and structural characteristics of the tank (which may vary from one vehicle to another).

Thus, in the case of a filling “without communication”, the data in particular relating to the geometry of the tank of the vehicles and to the quantity of gas remaining in the tank are not transmitted to the filling station. As a result the station must be programmed for a predetermined type of tank or must calculate and estimate missing data (cf. for example the documents FR 2948438A1 and FR 2948437A1).

In the case of filling “with communication”, the vehicle transmits all or some of this information for optimising the filling (cf. for example the protocol described in the document SAE J 2799).

One aim of the invention is to propose an improved filling method meeting the known constraints and being able to be applied to fillings both with and without communication.

Numerous documents such as EP1205704A1, U.S. Pat. No. 5,628,349, U.S. Pat. No. 5,752,552 and EP1336795 describe filling methods using density as a filling control parameter.

The document U.S. Pat. No. 6,786,245 describes a filling method in which the temperature and density of the gas are calculated from the temperature and from the pressure and composition of the gas. The density is calculated from the compressibility factor by means of second-order equations using virial coefficients applied to the state equation of the gas (this method is well known, in particular from the article “The equation of state of neon between 27 and 70 K” by R.M. Gibbons Gas Council, London Research Station, Michael Road, London SW6, UK (1969)). The document U.S. Pat. No. 6,786,245 does not however give a satisfactory method for monitoring the temperature in the tank during filling. As a result the density estimated in a relatively complex fashion is unsatisfactory (in particular since this estimation is based on a temperature taken to be equal to the temperature of the hydrogen emerging at the nozzle and not using the real gases compressibility factor).

One aim of the present invention is to overcome all or some of the drawbacks of the prior art noted above.

The inventors have developed a novel method for simple and reliable estimation of the temperature of the gas in the tank during filling (this temperature is generally not measurable in practice in the tank). The inventors also propose to use this calculated value of the temperature as first-level data that is then used for calculating or estimating second-level data such as density for example.

To this end, the method according to the invention, moreover in accordance with the generic definition given to it by the above preamble, is essentially characterised in that, for the step of determining the current temperature (T(ti)) of the gas in the tank, said temperature (T(ti)) is expressed and calculated solely as a function of the variables consisting of the current pressure (P(ti)) in the tank and the current quantity (m(ti)) of gas in the tank; the expression of the current temperature (T(ti)) as a function of the current pressure (P(ti)) and the current quantity (m(ti)) of gas in the tank being obtained from the state equation for the real gases in the tank P(ti)·V·10⁵=Z·n·R·T(ti), in which P(ti) is the pressure of the gas in the tank at time ti in bars, V the volume of the tank in m³, R the perfect gas constant equal to 8.314 in J/(mol·K), T(ti) the temperature of the gas in the tank at time ti in Kelvin (K) and Z the unitless compressibility factor, this compressibility factor Z being expressed as a function of the temperature (T(ti) and the pressure P(ti) of the gas in the tank according to a first-degree formula Z(ti)=(e·T(ti)+f)·P(ti)+g, in which e, f and g are coefficients predetermined empirically with e in basr⁻¹·K⁻¹, f in bars⁻¹, g unitless.

In addition, embodiments of the invention may comprise one or more of the following features:
the compressibility factor Z is expressed according to the formula Z(ti)=(e·T(ti)+f)·P(ti)+g, with g=0.99651, e=−1.75724×10⁻⁶ and f=1.17735×10⁻³,
the step of measuring the initial pressure (P(t0)) in the tank before filling consists of measuring the pressure (P) at the tank inlet, at a tank filling pipe, and, when the tank has a non-return valve at its inlet/outlet orifice, deducting from this measured value (P) the pressure level (Pcd) necessary for opening the non-return valve (P(t0)=P−Pcd),
the method comprises a step of determining the initial temperature (T(t0)) of the gas in the tank before filling, said initial temperature (T(t0)) of the gas in the tank being chosen from: the ambient temperature (Tamb) measured around the tank, a temperature measurement inside the tank, an estimation of the temperature of the gas in the tank from the ambient temperature and the history of the temperature values (T(ti)) in the tank,
the step of determining the current quantity (Q(ti)) of the gas transferred into the tank during filling uses at least one from: a flow meter placed upstream from the tank inlet in order to measure the quantity of gas transferred to the tank during filling, computing logic that determines this current quantity (Q(ti)) of the gas transferred into the tank from the pressure and temperature measurements upstream of the tank inlet,
the step of determining the initial quantity (m(t0)) of gas in the tank before filling uses the formula for calculating the initial mass m(t0) of gas in the tank in kg:

$$m ( t 0 ) = \frac{P ( t 0 ) \cdot {10}^{5} \cdot V \cdot M}{R \cdot T ( t 0 ) \cdot [ ( e \cdot T ( t 0 ) + f ) \cdot P ( t 0 ) + g ]}$$

in which the coefficient g=0.99651 unitless,

e=−1.75724×10⁻⁶ bar⁻¹·K⁻¹ and f=1.17735×10⁻³ bar⁻¹; M is the molar mass of the gas in kg/mol, V the volume of the tank in m³, the current quantity (m(ti)) of gas in the tank during filling being obtained by adding to this initial quantity m(t0) the current quantity (Q(ti)) of the gas transferred into the tank during filling: m(ti)=m(t0)+Q(ti),
the current temperature T(ti) of the gas in the tank (in K) is given by the formula:

$$T ( ti ) = \frac{- ( f \cdot P ( ti ) + g ) + \sqrt{{( f \cdot P ( ti ) + g )}^{2} + \frac{4 \cdot e \cdot {P ( ti )}^{2} \cdot {10}^{5} \cdot V \cdot M}{R \cdot m ( ti )}}}{2 \cdot e \cdot P ( ti )}$$

in which P(ti) is the current pressure of the gas in the tank at time ti in bars: g, e and f coefficients with e in bars⁻¹·K⁻¹, f in bars⁻¹, g unitless given by g=0.99651 unitless, e=−1.75724×10⁻⁶ bars⁻¹·K⁻¹ and f=1.17735×10⁻³ bars⁻¹, M the molar mass of the gas in kg/mol, V the volume of the tank in m³
the volume (V) of the tank in m³ is known or calculated,
the method is implemented using a hydrogen gas tank filling station comprising at least one source of hydrogen at high pressure, at least one transfer pipe selectively connecting the source to a tank, and electronic monitoring and control logic controlling the transfer of gas between the source and the tank, the filling station providing the electronic monitoring and control logic with at least one input parameter from among: the pressure (P) measured in the pipe upstream of the tank, this pressure (P) measured in the pipe at the inlet of the tank being assimilated to the pressure (P(ti) in the tank, the current mass flow (Q(ti)) of gas in the transfer pipe, the current temperature (T) of the gas in the transfer pipe, the filling duration (t), the maximum nominal pressure (Pmax) in the tank, the volume (V) of the tank, the ambient temperature (Tamb),
the method is implemented by a hydrogen gas tank filling station comprising at least one source of hydrogen at high pressure, at least one transfer pipe selectively connecting the source to a tank, and electronic monitoring and control logic controlling the transfer of gas between the source and the tank, the electronic logic being programmed to calculate at least one of the following output data: the initial density (ρ(t0)) of the gas in the tank before filling, the current density (ρ(ti)) of the gas in the tank during filling, a determined target density (ρf) in the tank corresponding to a criterion for stopping the filling, the current temperature (T(i)) of the gas in the tank,
the filling is controlled with at least one of the following control parameters: the current pressure (P(ti)) in the tank during filling, the current temperature (T(ti)) of the gas in the tank, the current density (ρ(ti)) of the gas in the tank during filling,
the filling is controlled with the current density (ρ(ti)) of the gas in the tank during filling, said current density (ρ(ti)) of the gas in the tank being calculated from the current temperature (T(i) of the gas in the tank calculated from the calculated current quantity (m(ti)) of gas in the tank and from the volume (V) of the tank (3) according to the formula ρ(ti))=m(ti)/V; with ρ(ti) in kg/m³, m(ti) in kg, and V in m³, the filling being controlled according to a current density (ρ(ti)) variation curve or straight line as a function of the predetermined time, the filling being interrupted when the current density reaches a given target value,
the filling rate is controlled by means of a pressure regulator of the proportional integral type,
the filling is controlled by means of a first pressure regulator of the proportional integral type that receives as an input parameter the current density (ρ(ti)) of the gas in the tank and regulates the filling according to this current density (ρ(ti)),
the filling is controlled by means of a second pressure regulator of the proportional integral type that receives as an input parameter the current temperature (T(ti)) or pressure (P(ti)) of the gas in the tank and regulates the filling according to this current temperature (T(ti)) or respectively current pressure (P(ti)),
the method uses an electronic selector, the selector making a comparison of the current temperature (T(ti)) of the gas in the tank with a maximum temperature predefined for this filling point and, when the current temperature (T(ti)) of the gas in the tank is higher than this maximum temperature predefined for this filling point, the selector activates the second pressure regulator of the proportional integral (PI) type and deactivates the first proportional integral regulator and, when the current temperature (T(ti)) of the gas in the tank is below this maximum temperature predefined for this filling point, the selector activates the first pressure regulator of the proportional integral (PI) type and deactivates the second proportional integral regulator,
the method uses a limiter of the filling rate supplied to the tank below a given threshold, for example 60 g/s.

The invention may also concern any alternative device or method comprising any combination of the aforementioned or following features.

Other particularities and advantages will emerge from a reading of the following description given with reference to the figures, in which:

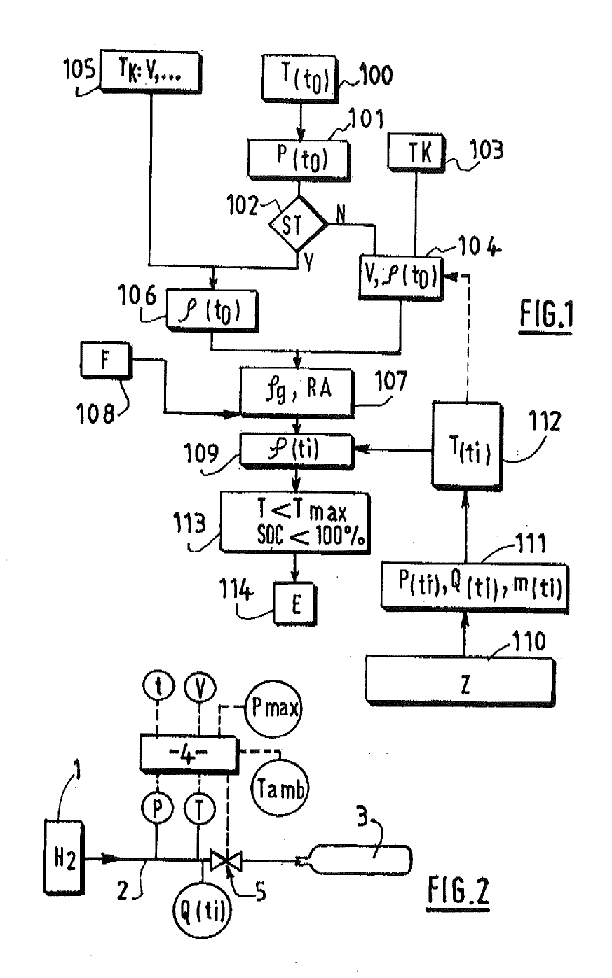

FIG. 1 shows a schematic partial view of a logic diagram illustrating a succession of possible steps in the implementation of an example embodiment of the method according to the invention,

FIG. 2 illustrates schematically and partially a detail of a possible example of a filling station structure according to the invention.

The invention may concern in particular the filling of hydrogen tanks of the adaptive type. The term adaptive meaning that the filling method adapts to parameters of the tank that are not necessarily completely known.

The method preferably takes place in two phases: a first estimation phase by calculation of several primary parameters, and then a second controlled filling phase with the temperature of the gas in the tank and the quantity of gas in the tank (or the density, which gives the same information as the quantity when the volume of the tank is known).

Before beginning the filling the method used by a filling station preferably determines one or more of the objects among:
the type of state equation used for the gas in question,
the initial pressure, the initial temperature in the tank,
the type of tank (for example type III or type IV, dimension, volume, etc.),
the nominal working pressure of the tank,
the quantity of gas initially contained in the tank,
the quantity of gas to be transferred into the tank.

These data are estimated by the station or communicated to the station preferably before calculating in real time the quantity (mass for example) and temperature of the gas in the tank during filling.

The use of a simple and reliable state equation based on empirical data is particularly advantageous.

According to the invention, the state equation of the gas uses the compressibility factor Z (Z=P·M/(ρ·R·T) with ρ the density, P the pressure, T the temperature, M the molar mass and R the perfect gas constant). The compressibility factor Z, a unitless quantity, is expressed from empirical data adjusted by means of a function F that depends on the current pressure P(ti) (that is to say in real time) and the current temperature T(ti):

Z(ti)=F(P(ti), T(ti))

For hydrogen, from the data of the National Institute of Standards and Technologies (NIST), an expression of the compressibility factor Z(ti) at time ti has been developed in accordance with the formula:

Z=a(T(ti))·P(ti)+g

with Z the coefficient of compressibility without dimension, T(ti) expressed in Kelvin (K), and g a unitless constant.

In addition the coefficient a (in bars⁻¹) is expressed as a linear function (of the 1^{st} degree) of the temperature T(ti), that is to say: a=e·T(ti)+f

Finally, Z=(e·T(ti)+f)·P(ti)+g (formula 1)

in which (P(ti)) is the pressure (in bars) of the gas at time ti, T(ti) the temperature of the gas in the tank at time ti in Kelvin (K) and with e in bar⁻¹·K⁻¹, f in bar⁻¹ and g unitless are empirically predetermined coefficients.

Preferably g=0.99651 unitless, e=−1.75724.10⁻⁶ bars⁻¹·K⁻¹ and f=1.17735.10⁻³ bars⁻¹.

The inventors have found that the value of the factor Z thus calculated has a maximum error 0.82% compared with the values given by the NIST for hydrogen.

The real gas state equation can be given by:

P·V=n·Z·R·T (P being the pressure in Pa, V the volume in m³, n the number of moles in mol, R the perfect gas constant in J/(mol·K), T the temperature in K and Z the unitless compressibility factor of the gas.

n=m/M (m being the mass in kg and M the molar mass in kg/mol).

Therefore P·V·M=Z·m·R·T, by replacing the pressure P in bars (instead of Pascals): P(in bars)·10⁵=P(in Pa) the result obtained is:

P(in bar)·10⁵·V·M=m·T·R·Z=m·T·R·((e·T+f)·P(in bars)+g)

Therefore for each instant ti,

P(ti)·10⁵·M·V=m(ti)·T(ti)·R·((e·T(ti)+f)·P(ti)+g) (equation B)

With P(ti) in bars, V(ti) in m³, T(ti) in K and R the perfect gas constant equal to 8.314 in J/(mol·K).

As shown schematically in FIG. 2, the tank 3 to be filled is conventionally filled with pressurised gas from at least one source 1 and via a filling pipe 2 provided with at least one control valve 5. Electronic logic 4 controls the filling from pressure measurement P, temperature T, flow-rate measurement Q(ti) in the transfer pipe 2. The electronic logic 4 also preferably receives the following parameters: the volume V of the tank 3, the nominal working pressure or maximum pressure Pmax for the tank, the time t and the ambient temperature.

The initial pressure in the tank T(t0) (before filling) can be approximated to the pressure P measured in the filling pipe 2 at the inlet to the tank 3. When the tank comprises an orifice provided with a non-return valve (“NRV”), the pressure level Pcd necessary for opening the non-return valve is deducted from this measured value P(t0)=P−Pcd (generally 0.5 to 2 bar).

The maximum allowable working pressure (MAWP) of the tank is generally 1.25 times the nominal working pressure (NWP). This nominal working pressure may for example be 350 bars or up to 750 bars.

The connectors of the transfer pipes 2 may be configured according to a given nominal working pressure (each connector is for example conformed for a given pressure).

The nature of the tank 3 has a strong influence on the thermal exchanges during filling. Preferably, the thermodynamic characteristics of the tank 3 are known to the filling station or transmitted automatically or manually to the station (type III or type IV tank for example).

The initial temperature (T(t0)) of the gas in the tank (before filling), if it cannot be measured, may be approximated to the ambient temperature Tamb around the tank, at the filling station.

The quantity Q(ti)−Q(t0) of gas transferred into the tank 3 during filling can be measured via a flow meter installed on the transfer pipe 2. A flow meter is in fact preferable in terms of precision to a calculated flow rate using an algorithm coupled to a valve.

A flowmeter gives a good measurement in the stable state. Since the initial quantity of gas Q(t0) and the volume of hydrogen are evaluated during transient states, the performance of the flow meter during the transient phases should preferably be verified in order to correctly determine the volume and initial quantity of hydrogen Q(t0). A correction factor may be provided where applicable to correct the data recorded during transient phases.

The initial quantity (mass) of gas contained in the tank 3 (at time t0 before filling) Q(t0), if it is not measurable directly, may be obtained from equation B below.

That is to say

m(t0)=(P(t0)·10⁵·V·M)/(R·T(t0)·(e·T(t0)+f)·P(t0)+g))

with M (molar mass) equal to 2*10⁻³ kg/mol for hydrogen and the pressure P(t0) in bar, e in bars⁻¹·K⁻, f in bars⁻¹, g unitless and the other parameters being in SI units.

The volume V of the tank is assumed to be known to the station, for example by communication, or failing this an estimation of the volume can be calculated (cf. the remarks and examples of known methods mentioned above).

From the above formulae it becomes easy to calculate the primary data consisting of the current temperature T(ti) and the quantity or mass m(ti)) of the gas in the tank 3. This is because, knowing the initial quantity of gas m(t0) in the tank and the volume V of the tank 3, it is possible to calculate the mass of gas present in the tank in real time (m(ti)=m(ti−1)+the quantity added between ti−1 and ti) and thus predict the temperature T(ti).

The real gas state equation can in particular be used for determining the temperature T(ti) in real time. Starting from equation B:

P(ti)·10⁵·M·V=m(ti)·R·T(ti)·((e·T(ti)+f)·P(ti)+g)=>(P(ti)·10⁵·M·V)/m(ti)=R·T(ti)·((e·T(ti)+f)·P(ti)+g)=>e·P(ti)·T²(ti)+(f·P(ti)+g)·T(ti)−(P(ti)·10⁵·M·V)/(R·m(ti))=0

The solution of this second-degree equation in (T(ti)) gives the expression of the current temperature (T(ti)) as a function of the known parameters.

This is because the equation a x²+b x+c=0 gives:

$$x = \frac{- b \pm \sqrt{{b}^{2} - 4 a c}}{2 a}$$

in our case this gives:

$$T ( ti ) = \frac{- ( f \cdot P ( ti ) + g ) + \sqrt{{( f \cdot P ( ti ) + g )}^{2} + \frac{4 \cdot e \cdot {P ( ti )}^{2} \cdot {10}^{5} \cdot V \cdot M}{R \cdot m ( ti )}}}{2 \cdot e \cdot P ( ti )}$$

In this way a simple and very effective expression of the temperature T(ti) of the gas at each instant ti is obtained.

The electronic logic 4 can thus optimise the filling while maintaining:
the temperature T(ti) of the gas in the tank below a safety threshold, for example 85° C.,
the pressure P(ti) in the tank below a maximum allowable working pressure (MAWP).

The input parameters may comprises the pressure P=P(ti) measured in the transfer pipe 2 upstream of the tank 3, the mass flow rate Q(ti) of gas in the transfer pipe 2, the current temperature T of the gas in the transfer pipe 2, the duration t of filling, the maximum nominal pressure Pmax of the tank (3), the thermal characteristics TK of the tank 3, the volume V of the tank 3 and the ambient temperature Tamb.

The output data may comprise: the current temperature T(i) of the gas in the tank, the initial density ρ(t0) of the gas in the tank 3 before filling, the current density ρ(ti) of the gas in the tank 3 during filling, a given target density ρf in the tank 3 corresponding to a criterion for stopping filling and a check that a maximum allowable working pressure (MAWP) has not been exceeded. The safety criterion is for example controlled by a single-bit signal from the electronic logic. The bit is for example:
equal to “1” when the pressure is below the maximum allowable threshold and the current density is less than the target density ρ_{f}, and
equal to “0” in the contrary case.

The filling can therefore be controlled by the density of the gas in the tank or other equivalent parameter (the quantity of gas for example).

By determining an initial density ρ(t0), a final target density ρ_{f} and a filling duration, it is possible to define a predetermined parameter controlled filling gradient.

The simultaneous control of the filling via the instantaneous density ρ(ti) and via the instantaneous temperature T(ti) can be achieved using two regulation devices, for example a first pressure regulator of the proportional integral (PI) type that receives as an input parameter the current density ρ(ti) of the gas in the tank 3 and regulates the filling as a function of this current density ρ(ti).

This is because the gaseous hydrogen tanks behave as storage capacities and a regulator for the filling is preferably a regulator of the PI (proportion integral) type.

A second pressure regulator, for example also of the proportion integral (PI) type can be provided. The second regulator receives as an input parameter the current temperature T(ti) or pressure P(ti) of the gas in the tank 3 and regulates the filling according to this current temperature T(ti) or current pressure P(ti) respectively.

These two regulators control the opening and closing of a valve 5 situated on the transfer pipe 2.

The first regulator receives as an input
the densities of the estimator of a predetermined density gradient, and
the current density ρ(ti).

As an output, this first regulator delivers a control signal fixing the opening percentage to be applied to the valve.

The second regulator receives as an input the maximum allowable temperature and the current temperature T(ti). As an output, the second regulator delivers a control signal fixing the opening percentage to be applied to the valve.

The output signals of the two regulators may be different. The first regulator may define a large opening percentage while the second regulator may give for example a relatively smaller opening percentage signal.

A temperature comparator may be provided in order to deliver as an output a signal controlling an electronic selector. The comparator compares as an input the temperature T(ti) of the gas in the tank 3 in real time with the maximum allowable pressure. If the current temperature T(ti) exceeds the maximum allowable temperature, the selector switches into the temperature regulation position. If the current temperature T(ti) is less than the maximum allowable temperature, the selector switches into the density regulation position.

A limiter may be provided for limiting the maximum gas flow supplied to the tank (for example 60 g/s of hydrogen in accordance with the standard SAEJ2601).

FIG. 1 illustrates an example of steps that may be implemented by a filling station according to the invention. In two first steps, the initial temperature T(t0) and the initial pressure P(t0) can be measured/determined. During a subsequent step, the station may determine whether a static communication is possible, that is to say whether parameters are able to be communicated to the station by the entity (bottle frame vehicle) comprising the tank.

If it is no (N), at step 103 parameters of the tank TK may where applicable be measured or communicated and at step 104 the volume V and the initial density ρ(t0) are calculated or estimated. If it is yes (Y), parameters TK and in particular the volume V of the tank are communicated to the station (step 105). After this communication the initial density ρ(t0) in this tank is calculated or estimated (as at step 104).

Whether or not there be communication, the following step 107 may be a step of calculating the final target density ρ_{f} for the tank. The duration F of the filling can be chosen or calculated at step 108 in order to define a density increase gradient RA.

During filling, the current density ρ(ti) can be calculated in real time (step 109). As described above, this current density ρ(ti) can be calculated from the expression of the compressibility factor Z as described above (step 110). This compressibility factor Z is then used with the current pressure P(ti), the current quantity m(ti) of gas in the tank in order to calculate the current temperature (steps 111 and 112). The current density p(t0) is then calculated from this temperature value T(ti) via the volume and the current quantity m(ti).

The station can regulate the filling by means of the current density ρ(ti) using the appropriate interruption conditions (the temperature must remain below the temperature Tmax and the filling rate SOC must be less than 100% (step 113)). When the interruption conditions are fulfilled, the filling is interrupted (step 114).

Preferably, the filling is of the static communication type. This type of communication makes it possible in fact to reduce the uncertainties in the estimation of parameters (volume etc.). Communication of real values to the filling station improves the optimisation of the filling.

Preferably the following data are communicated to the station:
the nominal working pressure (NWP) of the tank,
the volume V of the tank, the number of tanks, the ratio of the surface of the tank to its volume, the thermodynamic properties of the tank, its type (III or IV) etc.

These data may be transferred by wireless, by a barcode, a transmitter identification device of the radio frequency type (RFID), etc.

For filling a bus tank having a storage capacity of 20 to 40 kg of hydrogen, the end of the filling is preferably carried out with a compressor. This is because in this case the pressure differential between the transfer pipe and the tank is constant and easily measurable.

A measurement of the temperature of the gas at the transfer pipe may make it possible to calculate the enthalpy of the gas entering the tank.

1-13. (canceled)

14. A method for filling a tank with pressurized gas, the tank (3) to be filled being supplied with pressurized gas from at least one source (1) and via a filling pipe (2) provided with at least one control valve (5), in particular gaseous hydrogen, in order to achieve a predetermined target filling rate (ρ_{f}) expressed as the current density of gas (ρ(ti)) in the tank with respect to a target density (ρ_{f}), the filling being interrupted when a measured or estimated physical quantity (ρ(ti)) of the gas in the tank corresponds to the target filling level (ρ_{f}) or when the temperature (T(ti)) in the tank reaches a given maximum threshold (Tmax), the method comprising:
a step of measuring the initial pressure (P(t0)) in the tank before filling,
a step of determining the initial quantity (m(t0)) expressed by mass of gas in the tank before filling,
a step of measuring the current pressure (P(ti)) in the tank during filling,
a step of determining the current quantity (Q(ti)) expressed as the mass of gas transferred into the tank during filling,
a step of calculating the current quantity (m(ti)) expressed for example as the mass of gas in the tank during filing,
a step of determining the current temperature (T(ti)) of the gas in the tank during filing,
the method being characterised in that, for the step of determining the current temperature (T(ti)) of the gas in the tank, said temperature (T(ti)) is expressed and calculated solely as a function of the variables consisting of the current pressure (P(ti)) in the tank and the current quantity (m(ti)) of gas in the tank; the expression of the current temperature (T(ti)) as a function of the current pressure (P(ti)) and the current quantity (m(ti)) of gas in the tank being obtained from the state equation for the real gases in the tank P(ti)·V·10⁵=Z·n·R·T(ti), in which P(ti) is the pressure of the gas in the tank at time ti in bars, V the volume of the tank in m³, R the perfect gas constant equal to 8.314 in J/(mol·K), T(ti) the temperature of the gas in the tank at time ti in Kelvin (K) and Z the unitless compressibility factor, this compressibility factor Z being expressed as a function of the temperature T(ti) and the pressure P(ti) of the gas in the tank according to a first degree formula Z(ti)=(e·T(ti)+f)·P(ti)+g, in which e, f and g are coefficients predetermined empirically with e in bars⁻¹·K⁻¹, f in bar⁻¹, g unitless.

15. The method of claim 14, wherein the compressibility factor Z is expressed according to the formula Z(ti)=(e·T(ti)+f)·P(ti)+g, with g=0.99651, e=−1.75724×10⁻⁶ and f=1.17735×10⁻³.

16. The method of claim 14, wherein the step of measuring the initial pressure (P(t0)) in the tank (3) before filling consists of measuring the pressure (P) at the tank inlet, at a filling pipe (2) of the tank (3), and, when the tank (3) has a non-return valve at its inlet/outlet orifice, deducting from this measured value (P) the pressure level (Pcd) necessary for opening the non-return valve (P(t0)=P−Pcd),

17. The method of claim 14, wherein it comprises a step of determining the initial temperature (T(t0)) of the gas in the tank (3) before filling, said initial temperature (T(t0)) of the gas in the tank (3) being chosen from: the ambient temperature (Tamb) measured around the tank, a temperature measurement inside the tank (3), an estimation of the temperature of the gas in the tank from the ambient temperature and the history of the temperature values (T(ti)) in the tank.

18. The method of claim 14, wherein the step of determining the current quantity (Q(ti)) of the gas transferred into the tank during filling uses at least one from: a flow meter placed upstream from the tank inlet in order to measure the quantity of gas transferred to the tank during filling, or computing logic (4) that determines this current quantity (Q(ti)) of the gas transferred into the tank from the pressure and temperature measurements upstream of the tank (3) inlet.

19. The method of claim 14, wherein the step of determining the initial quantity (m(t0)) of gas in the tank before filling uses the formula for calculating the initial mass m(t0) of gas in the tank in kg:
$$m ( t 0 ) = \frac{P ( t 0 ) \cdot {10}^{5} \cdot V \cdot M}{R \cdot T ( t 0 ) \cdot [ ( e \cdot T ( t 0 ) + f ) \cdot P ( t 0 ) + g ]}$$
in which the coefficients g=0.99651 unitless, e=−1.75724×10⁻⁶ bar⁻¹·K⁻¹ and f=1.17735×10⁻³ bar⁻¹; M is the molar mass of the gas in kg/mol, V the volume of the tank in m³, the current quantity (m(ti)) of gas in the tank during filling being obtained by adding to this initial quantity m(t0) the current quantity (Q(ti)) of the gas transferred into the tank during filling: m(ti)=m(t0)+Q(ti).

20. The method of claim 14, wherein the current temperature T(ti) of the gas in the tank (in K) is given by the formula:
$$T ( ti ) = \frac{- ( f \cdot P ( ti ) + g ) + \sqrt{{( f \cdot P ( ti ) + g )}^{2} + \frac{4 \cdot e \cdot {P ( ti )}^{2} \cdot {10}^{5} \cdot V \cdot M}{R \cdot m ( ti )}}}{2 \cdot e \cdot P ( ti )}$$
in which P(ti) is the current pressure of the gas in the tank at time ti in bars: g, e and f coefficients with e in bar⁻¹·K⁻¹, f in bar⁻¹, g unitless, given by g=0.99651 unitless, e=−1.75724.10⁻⁶ bar⁻¹·K⁻¹ and f=1.17735.10⁻³ bar⁻¹, M the molar mass of the gas in kg/mol, V the volume of the tank in m³.

21. The method of claim 14, wherein the volume (V) of the tank in m³ is known or calculated.

22. The method of claim 14, wherein it is implemented by a hydrogen gas tank filling station comprising at least one source (1) of hydrogen at high pressure, at least one transfer pipe (2) selectively connecting the source (1) to a tank (3), and electronic monitoring and control logic (4) controlling the transfer of gas between the source (1) and the tank (3), wherein the filling station provides the electronic monitoring and control logic (4) with at least one input parameter from: the pressure (P) measured in the pipe (2) upstream of the tank (3), this pressure (P) measured in the pipe at the inlet of the tank (3) being assimilated to the pressure (P(ti) in the tank (3), the current mass flow (Q(ti)) of gas in the transfer pipe (2), the current temperature (T) of the gas in the transfer pipe (2), the filling duration (t), the maximum nominal pressure (Pmax) in the tank (3), the volume (V) of the tank (3), the ambient temperature (Tamb),

23. The method of claim 14, wherein it is implemented by a hydrogen gas tank filling station comprising at least one source (1) of hydrogen at high pressure, at least one transfer pipe (2) selectively connecting the source (1) to a tank (3), and electronic monitoring and control logic (4) controlling the transfer of gas between the source (1) and the tank (3), wherein the electronic logic (4) is programmed to calculate at least one of the following output data: the initial density (ρ(t0)) of the gas in the tank (3) before filling, the current density (ρ(ti)) of the gas in the tank (3) during filling, a target density (ρf) determined in the tank (3) corresponding to a criterion for stopping the filling, the current temperature (T(i)) of the gas in the tank (3).

24. The method of claim 14, wherein the filling is controlled with at least one of the following control parameters: the current pressure (P(ti)) in the tank (3) during filling, the current temperature (T(ti)) of the gas in the tank, the current density (ρ(ti)) of the gas in the tank (3) during filling.

25. The method of claim 14, wherein the filling is controlled with the current density (ρ(ti)) of the gas in the tank (3) during filling, said current density (ρ(ti)) of the gas in the tank (3) being calculated from the current temperature (T(i)) of the gas in the tank calculated from the calculated current quantity (m(ti)) of gas in the tank and from the volume (V) of the tank (3) according to the formula ρ(ti))=m(ti)/V; with ρ(ti) in kg/m³, m(ti) in kg, and V in m³, the filling being controlled according to a current density (ρ(ti)) variation curve or straight line as a function of the predetermined time, the filling being interrupted when the current density reaches a given target value (pf).

26. The method of claim 14, wherein the filling rate is controlled by means of at least one pressure regulator of the proportional integral (PI) type.
